(19) United States
(12) Patent Application Publication
(10) Pub. No.: US 2009/0196724 A1
(43) Pub. Date: Aug. 6, 2009

(54) EDGE CONTACT GRIPPER

(76) Inventors: HUI (FRED) CHEN, Burlingame, CA (US); JOHN S. LEWIS, Sunnyvale, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/026,000

(22) Filed: Feb. 5, 2008

(51) Int. Cl. B25J 9/10

(52) U.S. Cl. 414/590

(57) ABSTRACT

The present invention generally provides a method and apparatus for supporting and transferring a substrate. One embodiment of the present invention provides an apparatus configured for handling a substrate comprising a base member, a first finger movably connected with the base member, wherein the first finger is pivotable about a pivoting axis, a second finger movably connected with the base member, wherein the second finger is pivotable about the pivoting axis, the first and second fingers form an opening, and pivoting of the first and second fingers allow the opening to vary for receiving a substrate and for carrying the substrate by contacting an edge of the substrate, and an actuator connected with the first finger and second finger, wherein the actuator is configured to pivot the first and second fingers simultaneously along opposite directions.

### BACKGROUND OF THE INVENTION

1. Field of the Invention

This application relates to apparatus and method for semiconductor substrate processing. More specifically, this application provides methods and apparatus for transferring substrates during processing.

2. Description of the Related Art

Modern semiconductor processing systems include cluster tools which integrate a number of process chambers together in order to perform several sequential processing steps without removing the substrate from a highly controlled processing environment. The combination of chambers in a cluster tool, as well as the operating conditions and parameters under which these chambers are run, are selected to fabricate specific structures using a specific process recipe and process flow.

Once the cluster tool has been set up with a desired set of chambers and auxiliary equipment for performing certain process steps, the cluster tool will typically process a large number of substrates by continuously passing substrates through a series of chambers and process steps. Robots are typically used to pass the wafers in a cluster tool.

Substrate handling robots generally pick up substrates from processing chambers and place substrates into processing chambers. In some cases, robots may also rotate or flip the substrates between picking up and placing down. For example, during a chemical mechanical polishing (CMP) process, substrates generally enter a CMP tool in a horizontal orientation with device side down, are polished and rotated in a vertical orientation to be cleaned in a cleaner, and then rotated to the horizontal orientation and flipped to device side up for further processing. As a result, a substrate handling robot in such a cluster tool may need to be able to carry substrates at vertical and horizontal positions, and to rotate and flip the substrates.

Conventional substrate handlers require a relative large footprint to perform picking up, rotating and flipping functions. Additionally, typical substrate handlers also require high precision alignment when picking up substrates which slows down substrate transfer and limits system throughput.

Therefore, there is a need for a substrate handler with reduced footprint and increased throughput.

### SUMMARY OF THE INVENTION

The present invention generally provides a method and apparatus for supporting and transferring a substrate during processing.

One embodiment of the present invention provides an apparatus configured for handling a substrate, comprising a base member, a first finger movably connected with the base member, wherein the first finger is pivotable about a pivoting axis, a second finger movably connected with the base member, wherein the second finger is pivotable about the pivoting axis, the first and second fingers form an opening, and pivoting of the first and second fingers allow the opening to vary for receiving a substrate and for carrying the substrate by contacting an edge of the substrate, and an actuator connected with the first finger and second finger, wherein the actuator is configured to pivot the first and second fingers simultaneously along opposite directions.

Another embodiment of the present invention provides an apparatus configured for transferring substrates, comprising a substrate gripper configured to carry a substrate by contacting an edge, wherein the substrate gripper comprises a base member, a first finger movably connected with the base member, wherein the first finger is pivotable about a pivoting axis, a second finger movably connected with the base member, wherein the second finger is pivotable about the pivoting axis, the first and second fingers form an opening, and pivoting of the first and second fingers allow the opening to vary for receiving a substrate and for carrying the substrate by contacting an edge of the substrate, and an actuator connected with the first finger and second finger, wherein the actuator is configured to pivot the first and second fingers simultaneously along opposite directions, a flipping joint connected with the substrate gripper and configured to rotate the substrate gripper to change orientation of the substrate, and a rotating shaft connected with the flipping joint and configured to rotate the flipping joint and the substrate gripper about a central axis of the rotating shaft.

Yet another embodiment of the present invention provides an apparatus for processing a substrate, comprising a cleaning station configured to clean a vertically positioned substrate in a cleaning solution, wherein the cleaning station has a top opening configured to allow entrance and exit of the substrate, and a substrate handler configured to transfer substrates to and from the cleaning station, wherein the substrate handler comprises a substrate gripper configured to carry a substrate by contacting an edge, wherein the substrate gripper comprises a base member, a first finger movably connected with the base member, wherein the first finger is pivotable about a pivoting axis, a second finger movably connected with the base member, wherein the second finger is pivotable about the pivoting axis, the first and second fingers form an opening, and pivoting of the first and second fingers allow the opening to vary for receiving a substrate and for carrying the substrate by contacting an edge of the substrate, and an actuator connected with the first finger and second finger, wherein the actuator is configured to pivot the first and second fingers simultaneously along opposite directions, and a rotating shaft connected with the substrate gripper, wherein the rotating shaft is configured to rotate the substrate gripper to maneuver the substrate gripper in and out the cleaning station.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 schematically illustrates a cleaning system in accordance with one embodiment of the present invention.

FIG. 2A schematically illustrates the cleaning system of FIG. 1 with a substrate gripper in a close position.

FIG. 2B schematically illustrates the cleaning system of FIG. 1 with the substrate gripper in an open position.

FIG. 2C schematically illustrates the cleaning system of FIG. 1 with the substrate gripper at rotating positions.

FIG. 3A schematically illustrates a substrate gripper in accordance with one embodiment of the present invention.

FIG. 3B schematically illustrates an end effector of the substrate gripper of FIG. 3A.

FIG. 3C is a schematic partial enlarged view of the substrate gripper of FIG. 3A.

FIG. 3D is a schematic partial sectional view of a joint for the substrate gripper of FIG. 3A.

FIG. 4 schematically illustrates a substrate gripper in accordance with another embodiment of the present invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present invention relates to embodiments of methods and apparatus for transferring substrates during semiconductor manufacturing. More particularly, embodiments of the present invention provides an apparatus for handling substrates among vertical positions and horizontal positions.

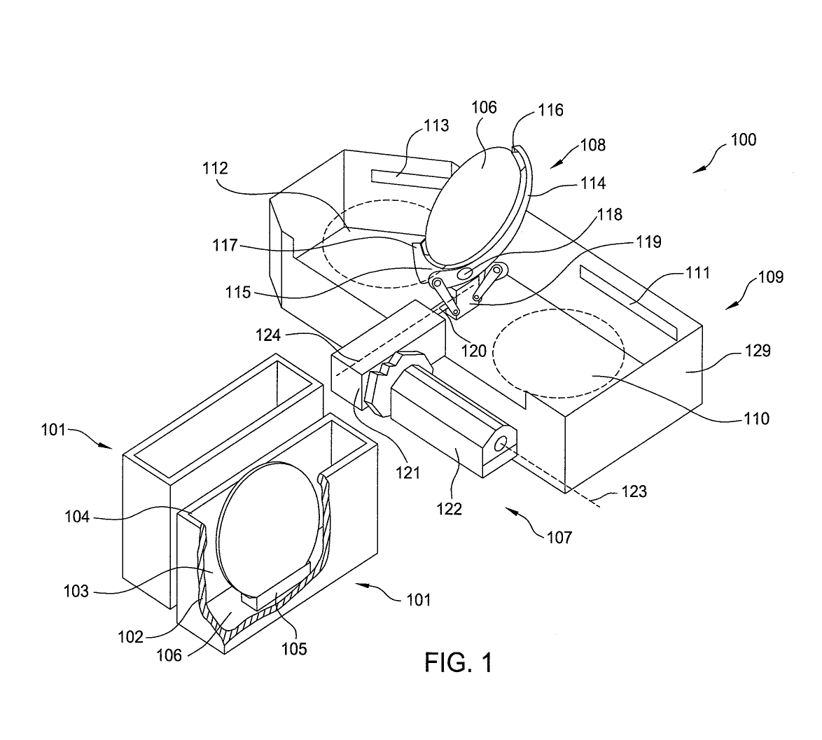

FIG. 1 schematically illustrates a cleaning system 100 in accordance with one embodiment of the present invention. The cleaning system 100 is configured to receive substrates to be cleaned in horizontal orientation, cleaning the substrates in vertical orientation, and returning cleaned substrate in horizontal orientation.

The cleaning system 100 generally comprises one or more cleaning stations 101. Each cleaning station 101 is configured to clean a substrate 106 in a vertical orientation. The cleaning station 101 comprises a body 102 defining a process volume 103, which is configured to accommodate the substrate 106 in a vertical position. The body 102 has an upper opening 104 configured to allow passage of the substrate 106. A substrate holder 105 may be disposed in the processing volume 103 to secure the substrate 106 during cleaning.

During processing, the substrate 106 is disposed in the cleaning station 101 emerging in a liquid cleaning solution retained within the process volume 103.

In one embodiment, the cleaning station 101 may further comprise other cleaning apparatus, for example megasonic generators configured to clean the substrate 106 by megasonic force, in addition to the liquid cleaning solution.

The cleaning system 100 further comprises a substrate handler 107 configured to transfer substrates between the one or more cleaning stations 101 and an interface dock 109. In one embodiment, the interface dock 109 comprises an input dock 110 wherein substrates to be processed are received in a horizontal orientation, and an output dock 112 wherein processed substrates are handed off for subsequent processing. In one embodiment, the input dock 110 and the output dock 112 may be positioned side by side within a frame 129. An input slit 111 may be formed through the frame 129 to allow a robot blade to enter and drop off a substrate onto the substrate handler 107. An output slit 113 may be formed through the frame 129 to allow a robot blade to enter and pick up a substrate from the substrate handler 107.

In one embodiment, the substrate handler 107 may be positioned between the one or more cleaning stations 101 and the interface dock 109. The substrate handler 107 comprises a substrate gripper 108 configured to carry a substrate 106 by contacting an edge.

The substrate gripper 108 is connected with a flipping joint 121 configured to rotate the substrate gripper 108 about an axis 124 to maneuver the substrate gripper 108 into either the input dock 110 or the output dock 112. In one embodiment, the flipping joint 121 may be connected with the substrate gripper 108 by an arm 120 extending from the substrate gripper 108 along the axis 124. In one embodiment, length of the arm 120 may be adjustable to allow flexibility.

The substrate handler 107 further comprises a rotating shaft 122 connected with the flipping joint 121. The rotating shaft 122 is configured to rotate the flipping joint 121 and the substrate gripper 108 about a central axis 123. The rotating shaft rotates the substrate gripper 108 between the one or more cleaning stations 101 and the interface dock 109. In one embodiment, the rotating shaft 122 is also capable of linear movement along the central axis 123, for example, to align the substrate gripper 108 with different cleaning stations 101.

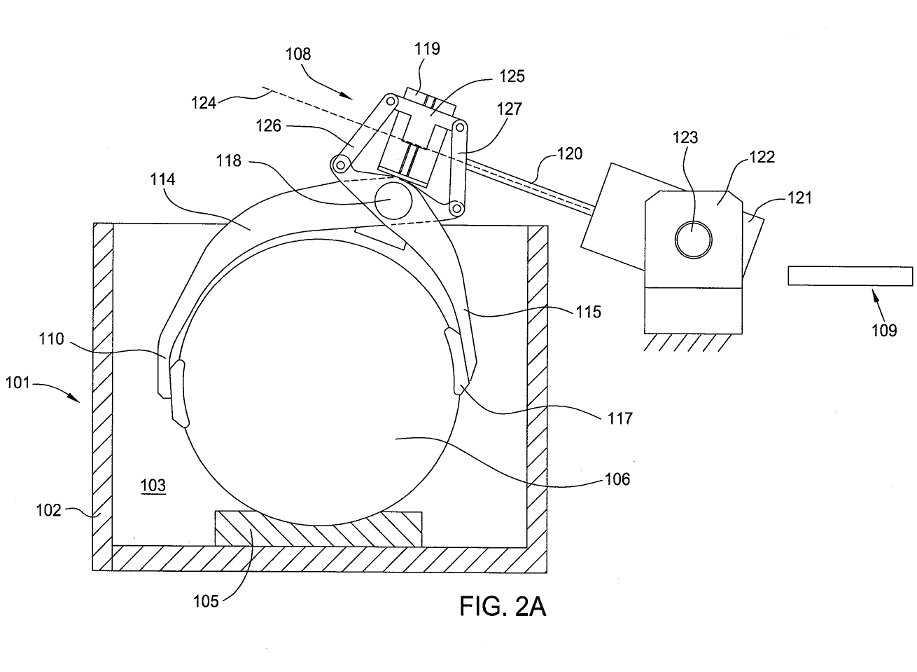

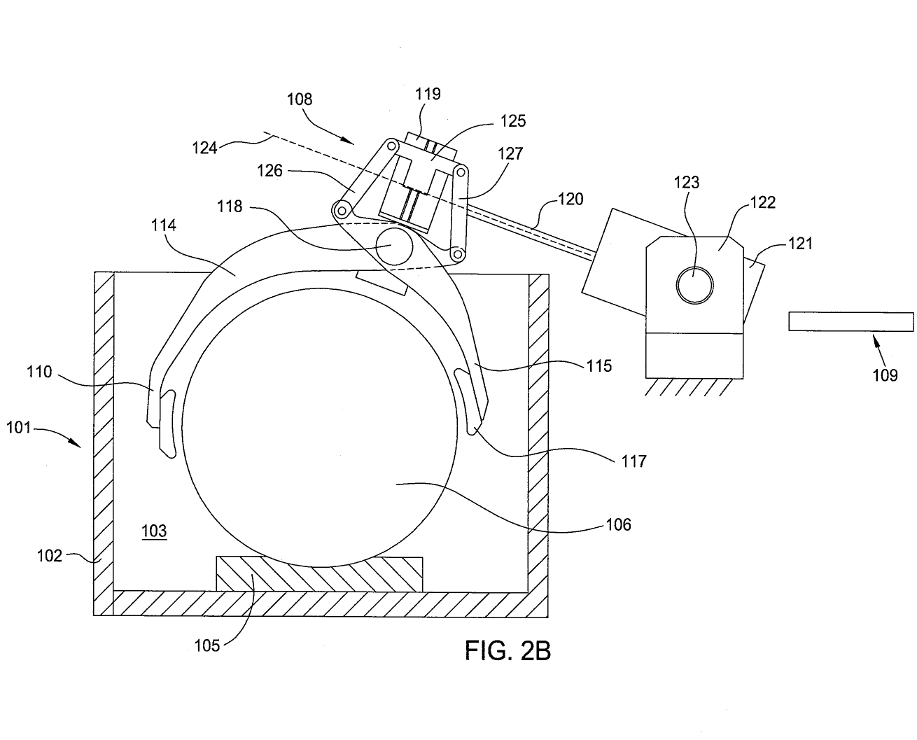

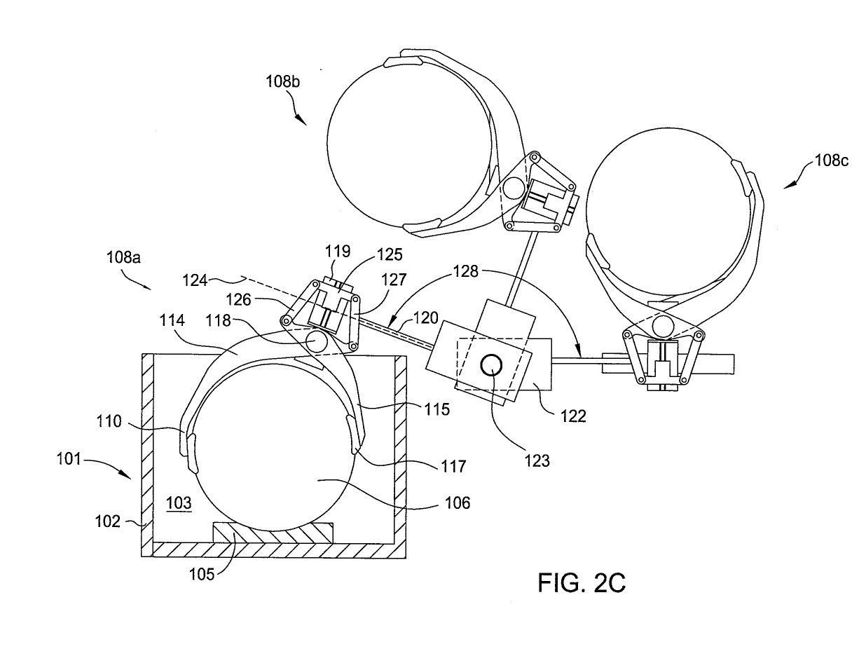

FIG. 2A schematically illustrates the cleaning system 100 with the substrate gripper 108 in a closed position. The substrate gripper 108 generally comprises a base member 119, which is connected to the flipping joint 121 via the arm 120. The substrate gripper 108 further comprises fingers 114, 115 pivotably connected with the base member 119. Both fingers 114, 115 are pivotable about a pivoting pin 118 which extends from the base member 119. The fingers 114, 115 form a gripping opening for contacting a substrate 106 by an edge. End effectors 116, 117 are coupled to the fingers 114, 115 respectively and are configured to contact the substrate 106 by the edge. Pivoting of the fingers 114, 115 allows the gripping opening to vary for receiving the substrate 106 and for carrying the substrate 106 by contacting the edge of the substrate 106.

An actuator 125 is connected with the fingers 114, 115 and is configured to pivot the fingers 114, 115 simultaneously but along opposite directions. In one embodiment, the finger 114 is connected to the actuator 125 via a linkage arm 127 and the finger 115 is connected to the actuator 125 via a linkage arm 126. In one embodiment, the actuator 125 is a single cylinder configured to move linearly relative to the base member 119.

To grab the substrate 106, the actuator 118 may move away from the pivoting pin 118 pulling the linkage arms 126, 127 which pivot the fingers 115, 114 respectively to close the gripping opening, as shown in FIG. 2A. To release the substrate 106, the actuator 118 may move towards the pivoting pin 118 pushing the linkage arms 126, 127 which pivot the fingers 115, 114 respectively to open the gripping opening, as shown in FIG. 2B.

FIG. 2C schematically illustrates the cleaning system 100 of FIG. 1 with the substrate gripper 108 rotating about the central axis 123. Rotation of the substrate gripper 108 allows the substrate gripper 108 to drop the substrate 106 into the cleaning station 101 and to pick up the substrate 106 from the cleaning station 101. The substrate gripper 108 rotates from a first position 108a wherein the substrate 106 is picked up or dropped off, through a transient position 108b, to a second position 108c wherein the substrate gripper 108 may be further rotated about the axis 124 to the input dock 110 or the output dock 112. The substrate gripper 108 travels a rotation angle 128 between the first position 108a and the second position 108c to maneuver the substrate 106 into/from the cleaning station 101.

In one embodiment, the substrate gripper 108 is asymmetric. The finger 114, which is far away from the rotating shaft 122, may be longer than the finger 115, which is close to the rotating shaft 122. The asymmetric configuration reduces the rotation angle 128 of the substrate gripper 108 compared to the configuration where the substrate gripper has fingers of equal length, thus, increase system throughput. Additionally, the asymmetric configuration also reduces the minimum size of the process volume 103 required to accommodate the substrate gripper 108, thus, reduces footprint of the system.

In one embodiment, the substrate gripper 108 may also move linearly along the axis 124, for example by extending and/or retracting the arm 120, to adjust to the physical arrangement of the system.

During processing, the substrate gripper 108 may start at the first position 108a, rotate about the axis 124 to arrive at the input dock 110, and open the fingers 114, 115. A robot blade may deliver a substrate to be processed through the slit 111 and the fingers 114, 115 may close upon arrival of the substrate and grab the substrate therebetween.

After securing the substrate, the substrate gripper 108 may rotate about the axis 124 and return the second position 108c. The substrate gripper 108 then rotates about the central axis 123 to the position 108a to drop off the substrate in the cleaning station 101. After positioning the substrate on the substrate holder 105 in the cleaning station 101, the substrate gripper 108 opens the fingers 114, 115 to release the substrate and rotates about the central axis 123 towards the position 108b to exit the cleaning station 101. The substrate is then ready to be cleaned in the cleaning station 101.

During cleaning of a substrate, the substrate gripper 108 may operate among the interface dock 109 and other cleaning stations 101 by moving linearly along the central axis 123 to align with other cleaning stations in the system.

Upon completion of the cleaning process in the cleaning station 101, the substrate gripper 108 returns to the first position 108a with fingers 114, 115 in open position, as shown in FIG. 2B. The substrate gripper 108 may pick up the cleaned substrate by closing the fingers 114, 115, and rotate about the central axis 123 to the second position 108c. In one embodiment, the substrate gripper 108 may need to move along the central axis 103 to align with the interface dock 109. Upon arriving at the position 108c, the substrate gripper 108 rotates about the axis 124 to the output dock 112, wherein a robot blade may come in from the slit 113 to retrieve the cleaned substrate.

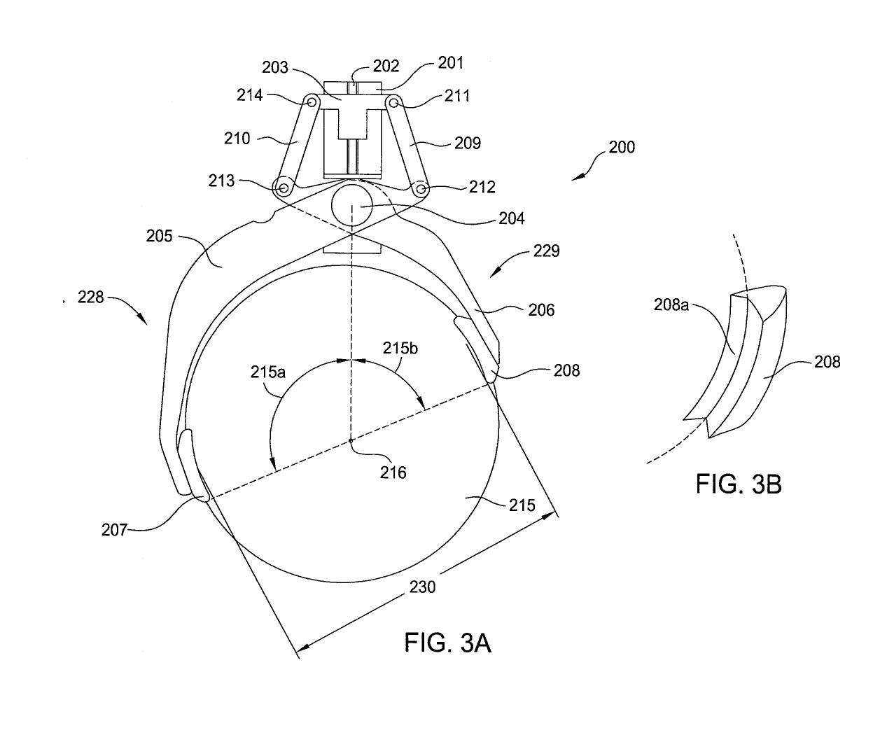

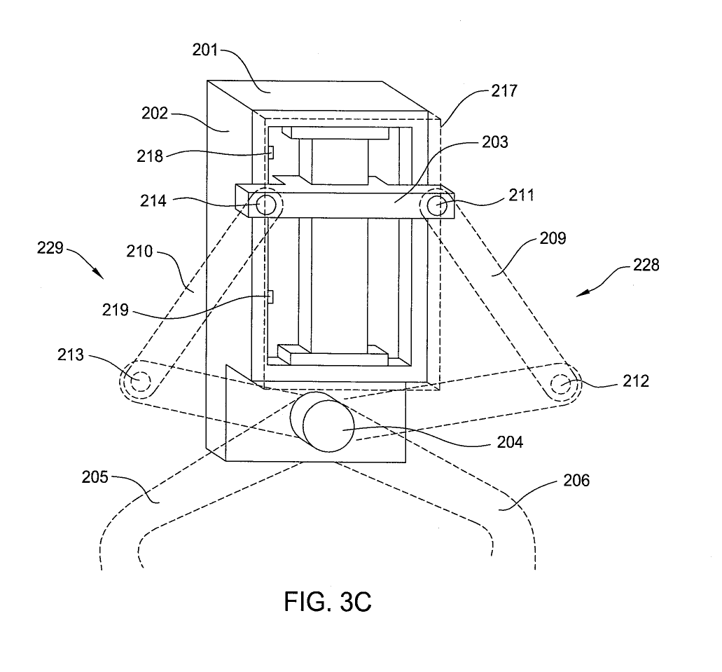

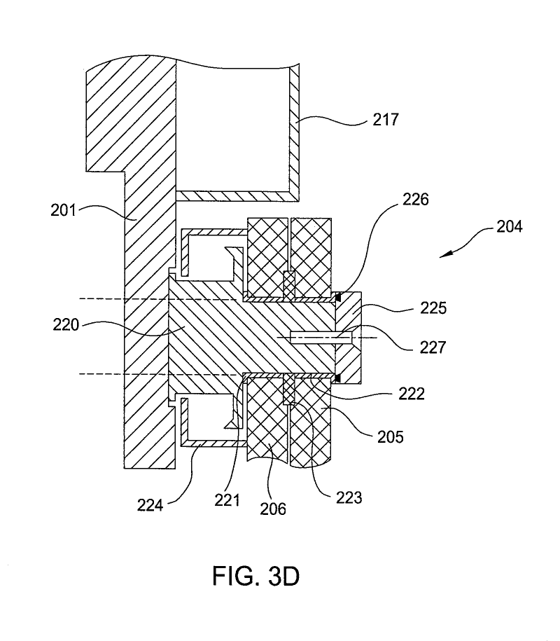

FIG. 3A schematically illustrates a substrate gripper 200 in accordance with one embodiment of the present invention. The substrate gripper 200 generally comprises a base member 201, which provides a frame for relative movements of the substrate gripper 200 and allows an interface for installation in a system.

The substrate gripper 200 comprises fingers 228, 229 pivotable about a pivoting joint 204 extending from the base member 201. The finger 228 comprises a curved body 205 coupled to the pivoting joint 204, an end effector 207 coupled to one end of the curved body 205, and a linkage arm 209 coupled to another end of the curved body 205. The end effector 207 is configured to contact a substrate 215 by an edge. In one embodiment, the linkage arm 209 is connected to the curved body 205 via a pivoting pin 212.

Similarly, the finger 229 comprises a curved body 206 coupled to the pivoting joint 204, an end effector 208 coupled to one end of the curved body 206, and a linkage arm 210 coupled to another end of the curved body 206. The end effector 208 is configured to contact the substrate 215 by an edge. In one embodiment, the linkage arm 210 is connected to the curved body 206 via a pivoting pin 213.

In one embodiment, the curved body 205 and the curved body 206 are different in length for effectiveness for transferring a substrate to and from a chamber with angled or curved trajectory. The curved bodies 205, 206 may be designed such that each of the finger 228, 229 covers an angle 215a, 215b respectively, wherein the angles 215a, 215b are vertexed at a center 216. The angles 215a, 215b may be designed according to system requirement. In one embodiment, the summation of the angles 215a, 215b may be equal to or larger than 180° such that the substrate 215 can not slip away from the end effectors 207, 208.

The fingers 228, 229 form a gripping opening 230 for contacting the substrate 215 by the edge. Pivoting of the fingers 228, 229 allows the gripping opening 230 to vary for receiving the substrate 215 and for carrying the substrate 215 by contacting the edge of the substrate 215.

Components of the substrate gripper 200 may be manufactured from plastic tolerant to process chemistry, and with high rigidity for position control and low friction to limit particle generation. In one embodiment, the base member 201, the linkage arms 209, 210, the curved bodies 205, 206 may be formed from polyethylene terephthalate (PET), polyvinyl chloride (PVC), or polyetheretherketones (PEEK). In one embodiment, the pivoting pins 211, 212, 213, 214 may be formed from stainless steel.

FIG. 3B schematically illustrates the end effector 208 of the substrate gripper 200 of FIG. 3A. The end effector 208 may have a curved body configured to match the curvature of the edge of a circular substrate being processed. The curved body may have a groove 208a formed therein to prevent substrate from slipping off.

The end effectors 207, 208 may be manufactured from plastic, which is tolerant to process chemistry and has low friction to limit particle generation. In one embodiment, the end effectors 207, 208 may be formed from polyetheretherketones (PEEK).

FIG. 3C schematically illustrates a partial enlarged view of the substrate gripper 200 of FIG. 3A, showing the actuation of the fingers 228, 229. A single cylinder 202 is disposed on the base member 201. The single cylinder 202 is configured to drive a sliding block 203 up and down. The sliding block 203 is coupled to the fingers 228, 229 through pivoting pins 211, 214 respectively.

As shown in FIG. 3C, when the sliding block 203 moves upwards, the linkage arms 209, 210 rotates clockwise and counter clockwise respectively, and the curved bodies 205, 205 rotates about the pivoting joint 204 counter clockwise and clockwise respectively, causing the gripping opening 230 to decrease, thus grabbing the substrate 215. On the other hand, when the sliding block 203 moves downwards, the linkage arms 209, 210 rotates counter clockwise and clockwise respectively, and the curved bodies 205, 205 rotates about the pivoting joint 204 clockwise and counter clockwise respectively, causing the gripping opening 230 to increase, thus releasing the substrate 215.

The substrate gripper 200 may further comprise sensors to detect the gripping opening 230. In one embodiment, the substrate gripper 200 comprises a closing sensor 218 and an opening sensor 219 disposed on the base member 201. The closing sensor 218 and the opening sensor 219 may be optical sensors that generate a signal when detecting the sliding block 203.

In one embodiment, the closing sensor 218 issues a signal indicating that the gripping opening 230 is small enough to secure a substrate between the fingers 228, 229 when the sliding block 203 passes the closing sensor 218. Any upward movement of the sliding block 203 after the signal from the closing sensor 218 indicates no substrate has been gripped by the fingers 228, 229, or the substrate has been broken. On the other hand, the opening sensor 219 issues a signal indicating that the gripping opening 230 is large enough to release a substrate between the fingers 228, 229 when the sliding block 203 passes the opening sensor 219. In one embodiment, the sensors 218, 219 may be infrared sensors.

In addition to using sensors 218, 219 to monitor and controlling the fingers 228, 229, the substrate gripper 200 may have a transparent cover 217 (shown in FIGS. 3C and 3D) to allow direct observation of the actuation.

The substrate gripper 200 may be used in an ambient of harsh chemistry, for example in a cleaning solution. Therefore, it is critical to construct the substrate gripper 200 to have tolerance to the chemistry, limited particle generation, rigidity large enough to allow precise position control, particularly for the pivoting joint 204.

FIG. 3D schematically illustrates a partial sectional view of the pivoting joint 204 for the substrate gripper 200 of FIG. 3A. The pivoting joint 204 generally comprises a pivoting pin 220 coupled to the base member 201. In one embodiment, the pivoting pin 220 may be made from stainless steel and coupled to the base member 201 by one or more screws.

The curved bodies 205, 206 of the fingers 228, 229 may be coupled to the pivoting pin 220 through self lubricating bearings 222, 221 respectively. A separator 223 may be disposed between the self lubricating bearings 222, 221 to assure that the fingers 228, 229 do not contact during rotation. In one embodiment, the separator 223 is a flat self-lubricating bearing. A cap 225 is coupled to the pivoting pin 220 by a screw 227 to keep the bearings 222, 221 from slipping off the pivoting pin 220. In one embodiment, an O-ring 226 may be used between the cap 225 and the bearing 222 to ensure a secure yet flexible installation. In one embodiment, a shield 224 may be disposed outside the pivoting pin 220 to further reduce particle generation.

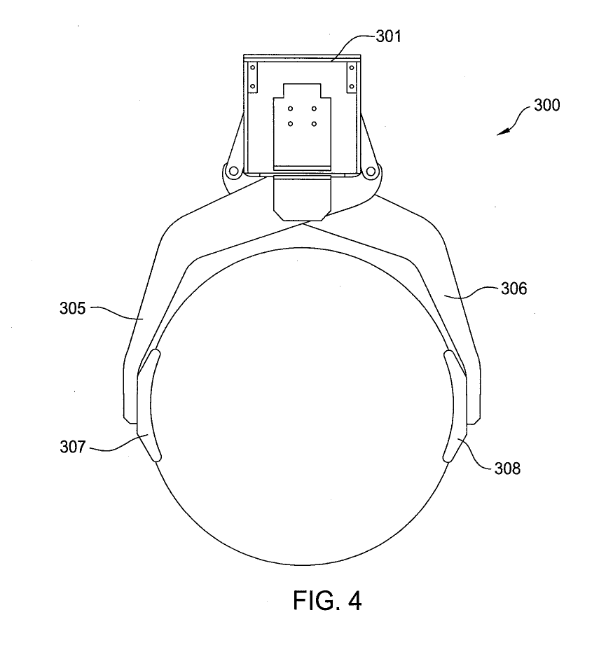

FIG. 4 schematically illustrates a substrate gripper 300 in accordance with another embodiment of the present invention. The substrate gripper 300 is similar to the substrate gripper 200 of FIG. 2A. In one embodiment, the substrate gripper 300 comprises fingers 305, 306 pivotably coupled to a base member 301. Each finger 305, 306 has an end effector 307, 308 attached thereto for contacting a substrate. The construction of the substrate gripper 300 is symmetric wherein the fingers 305, 306 have symmetric structure and symmetric movement. The substrate gripper 300 is efficient for handling substrates in a straight lined trajectory.

While the foregoing is directed to embodiments of the present invention, other and further embodiments of the invention may be devised without departing from the basic scope thereof, and the scope thereof is determined by the claims that follow.

What is claimed is:

1. An apparatus configured for handling a substrate, comprising:
a base member;
a first finger movably connected with the base member, wherein the first finger is pivotable about a pivoting axis;
a second finger movably connected with the base member, wherein the second finger is pivotable about the pivoting axis, the first and second fingers form an opening, and pivoting of the first and second fingers allow the opening to vary for receiving a substrate and for carrying the substrate by contacting an edge of the substrate; and
an actuator connected with the first finger and second finger, wherein the actuator is configured to pivot the first and second fingers simultaneously along opposite directions.

2. The apparatus of claim 1, wherein the first finger is longer than the second finger.

3. The apparatus of claim 1, wherein each of the first finger and second arm comprises:
an elongated body connected with the base member about the pivoting axis; and
an end effector coupled to one end of the elongated body, wherein the end effector is configured to contact the substrate.

4. The apparatus of claim 3, wherein each of the first finger and second finger further comprises:
a linkage arm pivotably coupled to the elongated body and the actuator, wherein the linkage and the end effector are on opposite side of the pivoting axis.

5. The apparatus of claim 1, further comprises a sensor assembly configured to detect attributes of the opening.

6. The apparatus of claim 1, further comprises a pivoting pin extending from the base member, wherein the first and second fingers are pivotable about the pivoting pin.

7. The apparatus of claim 6, further comprises a first polymer bearing coupled between the first finger and the pivoting pin and a second polymer bearing coupled between the second finger and the pivoting pin.

8. The apparatus of claim 1, wherein the actuator comprises a cylinder moves linearly relative to the base member.

9. The apparatus of claim 8, further comprises location sensors configured to detect location of the cylinder.

10. An apparatus configured for transferring substrates, comprising:
a substrate gripper configured to carry a substrate by contacting an edge, wherein the substrate gripper comprises:
a base member;
a first finger movably connected with the base member, wherein the first finger is pivotable about a pivoting axis;
a second finger movably connected with the base member, wherein the second finger is pivotable about the pivoting axis, the first and second fingers form an opening, and pivoting of the first and second fingers allow the opening to vary for receiving a substrate and for carrying the substrate by contacting an edge of the substrate; and
an actuator connected with the first finger and second finger, wherein the actuator is configured to pivot the first and second fingers simultaneously along opposite directions;
a flipping joint connected with the substrate gripper and configured to rotate the substrate gripper to change orientation of the substrate; and
a rotating shaft connected with the flipping joint and configured to rotate the flipping joint and the substrate gripper about a central axis of the rotating shaft.

11. The apparatus of claim 10, wherein each of the first finger and second arm comprises:
an elongated body connected with the base member about the pivoting axis; and
an end effector coupled to one end of the elongated body, wherein the end effector is configured to contact the substrate.

12. The apparatus of claim 11, wherein each of the first finger and second finger further comprises:
a linkage arm pivotably coupled to the elongated body and the actuator, wherein the linkage and the end effector are on opposite side of the pivoting axis.

13. The apparatus of claim 10, further comprises a sensor assembly configured to detect attributes of the opening.

14. The apparatus of claim 10, wherein the first finger is longer than the second finger.

15. The apparatus of claim 10, wherein the flipping joint is connected to an arm extended from the base member of the substrate gripper, and the substrate gripper is rotated by the flipping joint about an axis of the arm.

16. The apparatus of claim 15, wherein the arm is extendable along the axis.

17. An apparatus for processing a substrate, comprising
a cleaning station configured to clean a vertically positioned substrate in a cleaning solution, wherein the cleaning station has a top opening configured to allow entrance and exit of the substrate; and
a substrate handler configured to transfer substrates to and from the cleaning station, wherein the substrate handler comprises:
a substrate gripper configured to carry a substrate by contacting an edge, wherein the substrate gripper comprises:
a base member;
a first finger movably connected with the base member, wherein the first finger is pivotable about a pivoting axis;
a second finger movably connected with the base member, wherein the second finger is pivotable about the pivoting axis, the first and second fingers form an opening, and pivoting of the first and second fingers allow the opening to vary for receiving a substrate and for carrying the substrate by contacting an edge of the substrate; and
an actuator connected with the first finger and second finger, wherein the actuator is configured to pivot the first and second fingers simultaneously along opposite directions; and
a rotating shaft connected with the substrate gripper, wherein the rotating shaft is configured to rotate the substrate gripper to maneuver the substrate gripper in and out the cleaning station.

18. The apparatus of claim 17, wherein the first finger is longer than the second finger.

19. The apparatus of claim 17, wherein the substrate handler further comprise:
a flipping joint connected with the substrate gripper and configured to flip the substrate gripper to position the substrate in an input docking station or an output docking station.

20. The apparatus of claim 19, wherein the input docking station and the output docking station accommodate substrates being transferred to and from the substrate gripper in a horizontal orientation.
